(19) United States
(12) Patent Application Publication
(10) Pub. No.: US 2026/0330519 A1
(43) Pub. Date: Oct. 22, 2026

(54) Decentralized AI-Driven Multi-Industry Service Matching and Procurement System with Scalable Modular Architecture

(71) Applicant: Paul Deitz, League City, TX (US)

(72) Inventor: Paul Deitz, League City, TX (US)

(21) Appl. No.: 19/638,214

(22) Filed: Apr. 3, 2026

Related U.S. Application Data
(60) Provisional application No. 63/783,348, filed on Apr. 4, 2025.

(51) Int. Cl. G06Q 30/0601; G06Q 30/018

(52) U.S. Cl. CPC G06Q 30/0611; G06Q 30/018

(57) ABSTRACT

A decentralized Web3 platform employs agentic artificial intelligence and low-latency payment rails to match project owners with service providers and optimize real-time procurement of materials and tools across all industries. The operational flow begins with a free AI-vetted quote, followed by user choice between a DIY $25 package or a $50 deposit for 3 contractor quotes, with seamless path switching. The system includes vetting with photos and Q&A, “Buy Now” execution with shipping or in-store pickup alerts, smart contract payments, full-cost satisfaction guarantee, and an unlimited referral system. The modular architecture supports continuous AI improvement through data feedback loops for superior user experience and market dominance.

### CROSS-REFERENCE TO RELATED APPLICATIONS

This application claims the benefit under 35 U.S.C. § 119(e) of U.S. Provisional Patent Application No. 63/783,348, filed Apr. 4, 2025.

### BACKGROUND OF THE INVENTION

Traditional platforms require upfront payments, lack integrated procurement, and provide limited transparency or consumer protection. There is a need for a decentralized system that starts with a free AI-vetted quote and offers a clear, low-risk operational flow with easy path switching, real-time optimization, and strong guarantees.

### SUMMARY OF THE INVENTION

The present invention provides a decentralized AI-driven multi-industry service matching and procurement system with a complete operational process. The system begins with a free AI-vetted quote, allows user selection between a DIY $25 package and a $50 deposit for 3 contractor quotes with seamless switching, enables “Buy Now” with smart contract execution on low-latency rails, and includes a full-cost satisfaction guarantee and unlimited referral system. The architecture is modular and scalable, supporting multimodal interfaces, tokenized assets, cross-chain oracles, and continuous AI improvement.

### BRIEF DESCRIPTION OF THE DRAWINGS

FIG. 1 illustrates the blockchain and payment rail infrastructure of the system.

FIG. 2 illustrates the AI workflow and overall operational process.

FIG. 3 illustrates microservices.

FIG. 4 illustrates security & compliance.

FIG. 5 illustrates project management.

FIG. 6 illustrates user access.

FIG. 7 illustrates AI matching, regulatory compliance, and dynamic allocation.

### DETAILED DESCRIPTION OF THE INVENTION

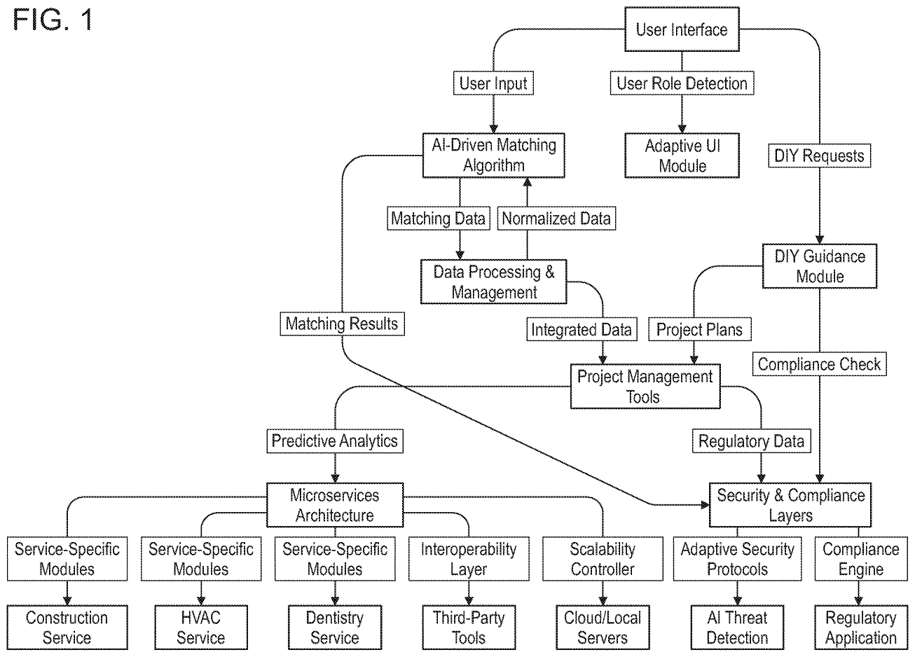

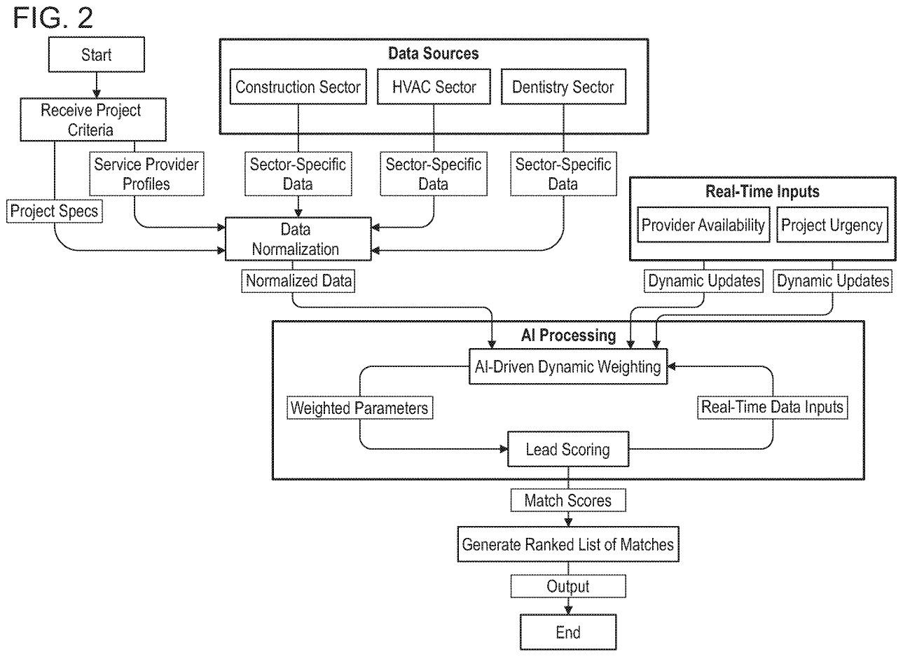

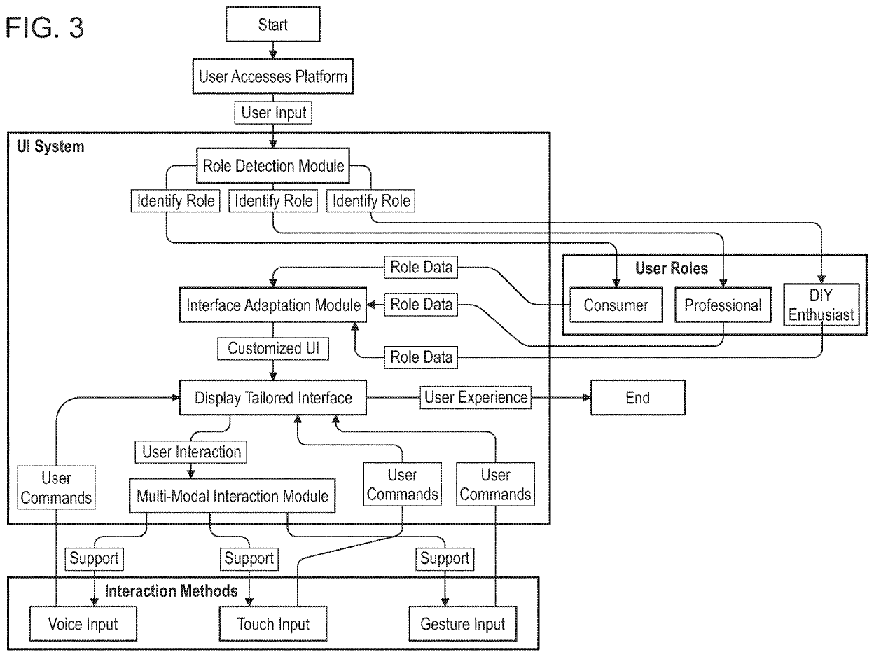

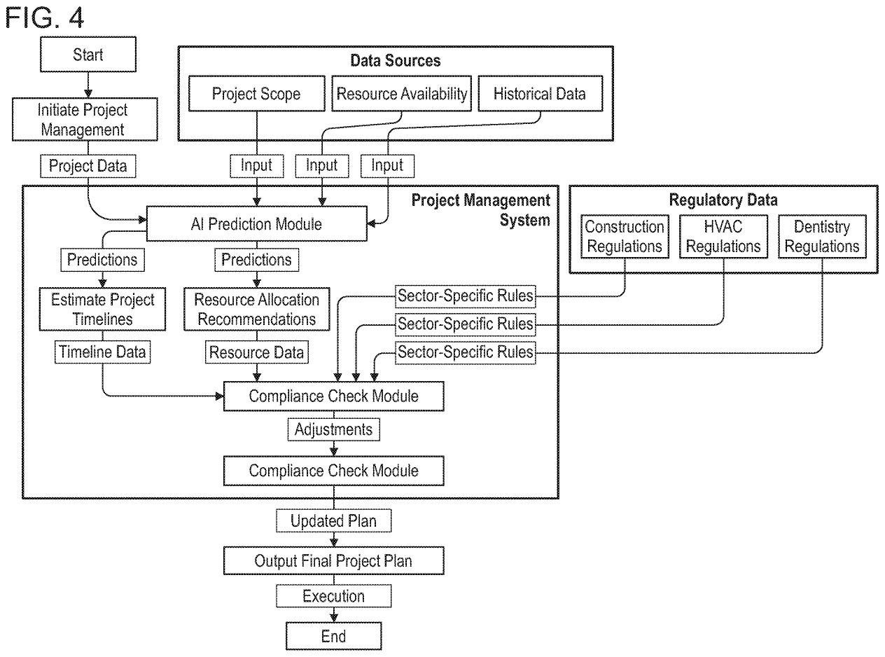

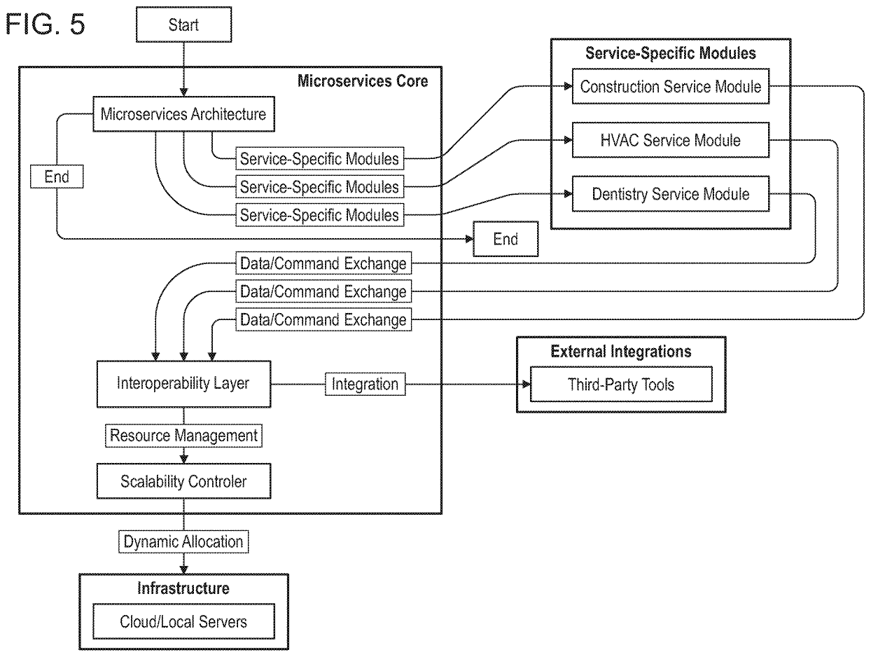

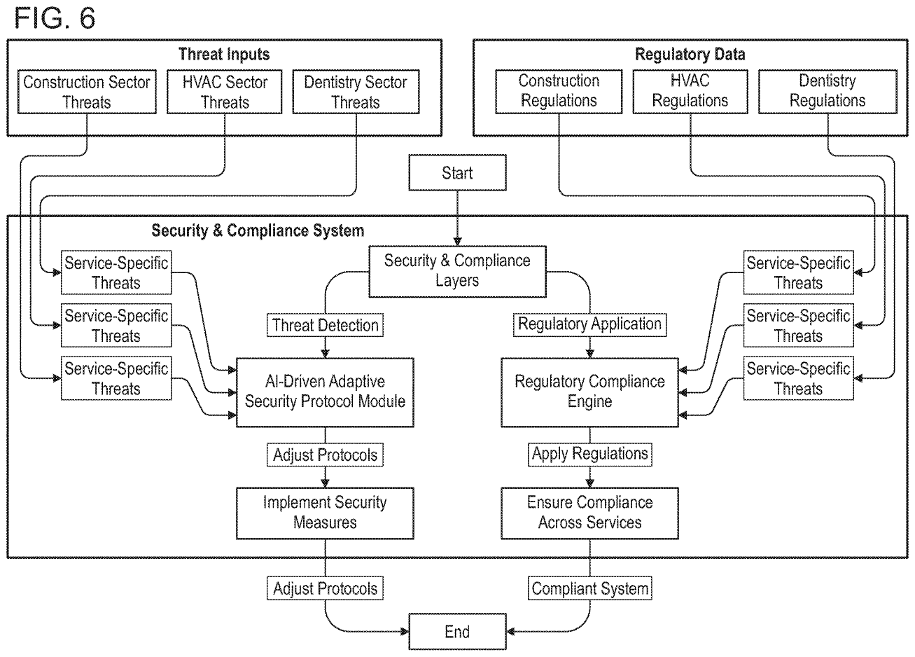

The “TheoMate” system is a Web3.0 platform that dynamically matches service providers with project owners and procures supplier materials and tools across all industries using decentralized ledger technology for data storage, agentic artificial intelligence for real-time matching, vetting, and procurement optimization, and low-latency payment rails for cryptocurrency-based financial settlements via smart contracts, as illustrated in FIGS. 1-7 and described more fully below.

### Complete Operational Process/Overall Flow

1. Free Quote Generation

User submits a project request via the platform. The agentic AI immediately generates a free rough quote with an optimized material/tool list and provider suggestions. The quote is vetted using real-time data. All input (description, location, photos, basic Q&A) is normalized and fed back into the AI for continuous improvement.
2. AI Vetting & Normalization

Agentic AI normalizes the input data (text+photos via advanced computer vision and multimodal models). Additional Q&A is conducted if needed to refine scope. The system flags any sector-specific compliance or regulatory needs.
3. Path Selection

After the Free Quote, the User Chooses:
DIY Path ($25 Package): User pays $25 and receives a complete package including detailed scope, step-by-step instructions, video links, optimized material/tool list, and “Buy Now” buttons for missing items.
Contractor Path ($50 Deposit for 3 Quotes): User pays $50 deposit for three AI-selected, vetted contractor quotes. Each quote includes provider profile, optimized material list, total price, and timeline.
4. Path Switching

At any time before final commitment, the user can switch from the contractor path to the DIY path for a partial refund plus the DIY package.
5. “buy Now” Execution

User or provider triggers “Buy Now” for materials/tools or provider booking. The feature supports shipping (default) or in-store pickup with proximity alerts and configurable distance thresholds. Consumer blockchain signature verifies the order. Smart contracts on low-latency rails (XRP Ledger or Stellar) handle escrow, payment splitting, and logging.
6. Project Execution & Completion

For contractor jobs, the provider completes the work. Both user and provider upload completion photos and logs. Smart contract releases final payment minus the scalable success fee upon verified completion.
7. Satisfaction Guarantee & Dispute Resolution

AI mediates disputes using submitted evidence (photos, logs). Unresolved contractor jobs trigger full-cost replacement coverage up to the original project cost, funded by the platform reserve.
8. Referral Giveaway & Data Feedback Loop

Unlimited referral entries are tracked on the blockchain for periodic prize drawings. All interactions (quotes, matches, outcomes, photos, Q&A) feed back into the AI for continuous improvement.

### Technical Components

1. Decentralized Data Storage and Payment Rails

Data is stored on one or more decentralized ledgers, with preference for low-latency rails such as XRP Ledger and Stellar for payment execution, escrow, and logging. Hybrid architectures allow complex logic on secure Layer-2 networks while routing high-frequency payments via XRP or XLM rails via cross-chain oracles.
2. Agentic Ai Matching, Vetting & Procurement Engine

The AI normalizes multi-industry data and generates optimized real-time lists using user-selected filters with dynamic weighting and autonomous re-optimization. It performs quote comparison and supports sector-specific compliance during matching.
3. Financial Settlements & Quality Assurance

After the free quote and path selection, scalable success-based fees are applied only on completed projects. The full-cost satisfaction guarantee is funded by a platform reserve with AI-mediated dispute resolution.
4. Supplier & Provider Procurement (“buy Now”)

“Buy Now” converts quotes to orders with consumer blockchain signature verification, supporting shipping or in-store pickup with proximity alerts. Smart contracts handle verification and payment on low-latency rails.
5. Modular Architecture & Scalability

Microservices enable scaling across industries and ledgers. The system supports multimodal user interfaces for enhanced accessibility and future integration of additional filters and enhanced agentic AI capabilities.

1. A decentralized computer-implemented method for multi-industry service matching and procurement comprising:
generating a free AI-vetted rough quote with optimized material and tool lists upon project intake with photos and Q&A;
offering path selection between a DIY $25 package and a $50 deposit for 3 contractor quotes, with the ability to switch paths at any time;
generating, by an agentic artificial intelligence engine, optimized real-time service provider, material, and tool lists based on user-selected industry-specific filters including proximity, price, rating, supplier or provider, availability, and experience;
executing a “Buy Now” feature with shipping or in-store pickup and proximity alerts, triggering smart contract execution on low-latency rails for payment and logging; and
applying a scalable success-based fee via smart contract only upon completion of a matched project, with a full-cost satisfaction guarantee for unresolved disputes.

2. The method of claim 1, wherein the full-cost satisfaction guarantee is funded through a smart contract reserve and AI mediates disputes using submitted evidence including photos and logs.

3. The method of claim 1, wherein the agentic AI engine performs autonomous quote comparison, dynamic filter weighting, and real-time re-optimization when supplier stock or provider availability changes using multimodal models and computer vision.

4. The method of claim 1, wherein service providers maintain free accounts on the platform and the scalable success-based fee is charged only upon successful completion and verification of the matched project.

5. The method of claim 1, further comprising an unlimited referral giveaway system with blockchain-tracked entries for periodic prize drawings.

6. The method of claim 1, wherein the “Buy Now” feature supports tokenized inventory and provider booking with automatic verification before payment release on low-latency rails such as XRP Ledger and Stellar.

7. The method of claim 1, wherein the system architecture is modular and microservices-based, enabling scalability across multiple decentralized ledgers including hybrid integration of XRP Ledger and Stellar rails with cross-chain oracles.

8. The method of claim 1, further comprising a compliance engine that applies sector-specific regulatory rules during matching and procurement to ensure adherence to applicable regulations using real-time oracle data.

9. The method of claim 1, wherein the AI engine normalizes multi-industry data including photographic evidence via advanced computer vision and multimodal models and generates optimized material and tool lists by evaluating best value across multiple suppliers in real time.

10. The method of claim 1, wherein the “Buy Now” feature includes a proximity alert with configurable distance threshold and suggests shipping when appropriate, with the system supporting multi-modal user interfaces (voice, touch, gesture) for enhanced accessibility.

11. The method of claim 1, wherein the scalable success-based fee is tiered based on project value and is deducted automatically by the smart contract before distributing payment to the provider on low-latency rails.

12. The method of claim 1, wherein all interactions, including the free quote, path selection, and completion data, feed back into the AI for continuous improvement of matching, optimization, and user experience.
